(19) United States
(12) Patent Application Publication
(10) Pub. No.: US 2004/0045500 A1
(43) Pub. Date: Mar. 11, 2004

(54) Coater with an adjustable filter and method

(75) Inventor: Wayne A. Damrau, Wisconsin Rapids, WI (US)

Correspondence Address: Pyle & Piontek, Suite 850, 221 N. LaSalle Street, Chicago, IL, 60601, US

(73) Assignee: Stora Enso North America Corp.

(21) Appl. No.: 10/237,839

(22) Filed: Sep. 9, 2002

(51) Int. Cl. B05C 11/02

(52) U.S. Cl. 118/110; 118/600; 118/300; 118/123

(57) ABSTRACT

A jet type coater with a nozzle orifice is provided with an adjustable, internal filter or screen in the head of the coater. The filter has orifices or slots which are formed by relatively movable members and is adjustable to a size smaller than that of the nozzle orifice, to keep the nozzle orifice unclogged and functioning. The internal filter is also easily clearable on the run without shutdown and cleanable with coating liquid and/or water.

### FIELD OF THE INVENTION

The present invention relates to an internal filter for a fountain type, jet type or other type coater which ejects coating through an orifice or slot and a method of use. More particularly, the invention relates to an adjustable or clearable filter and its method of use, the adjustable filter being clearable, on the run, and cleanable, as necessary, to ensure unrestricted performance of the coater.

Also, filtering of the coating, in a manner adjustable to be set at a filter orifice or slot sizing smaller than that of the coater nozzle orifice to ensure not clogging (partial or total blockage) of the coater nozzle orifice is provided, as is an adjustable or clearable filtering method.

### PRIOR ART

Fountain type and jet type coaters are known. Also, filtering of an extrusion type coating, such as a magnetic solution for forming a magnetic recording tape or the like, is known. It is also known to place a filter externally of, but closely adjacent to and upstream of, the coater. It is also known to place a fixed type screen within a coater. All these filters and screens have had the disadvantage of becoming plugged and requiring cleaning or replacement, often necessitating shutting down of the processing line, be it a coater line or a paper making line with coaters thereon. Even where these prior art filters could be replaced on the run, the usually presented additional flow paths are still capable of generating/causing additional coater clots or agglomerations.

### BRIEF SUMMARY OF THE PRESENT INVENTION

According to the present invention there is provided a method or process for operating a jet coater or other type coater for coating a paper web which applies a flow or a jet coating liquid through an orifice or nozzle onto a moving surface to coat a web of paper, comprising the steps of admitting the coating into a coating head of the jet or other type coater under pressure, passing the coating through an internal filter or screen within the coater, filtering the coating with the internal filter, and forcing the filtered coating out in a jet through a nozzle orifice onto a moving surface for coating paper. The coater nozzle or orifice is of the type that, if unfiltered coating is applied, it is subject, generally due to its small (narrow) size, to occasional plugging or clogging, at least partially, somewhere along its length (cross machine direction).

Still further according to the present invention there is provided a jet or other type coater which applies a jet or flow of coating liquid onto a moving surface be it initially a roll surface or the paper web directly to coat the paper web, comprising a coater head, the coater head having an entrance for the admission of coating liquid under pressure and a nozzle or restricting orifice therein for application of coating onto the moving surface, a screen or filter within said coater head located between said entrance and said nozzle orifice for filtering the coating liquid after passing through said entrance and before reaching the nozzle orifice, whereby coating agglomerates or clots which may be contained in the coating liquid are filtered out by the filter before reaching the coating nozzle orifice and preventing nozzle orifice blockage, the screen or filter being clearable, on the run, and cleanable, as necessary. The filter or screen comprises relatively movable portions, defining the screen or filter openings and may be cleared by moving the portions relative to one another. For convenience, this relative motion may be caused by means outside the coater itself The screen size opening can also be adjusted to accommodate different size nozzle openings by moving the defining portions relative to one another.

### DESCRIPTION OF THE DRAWINGS

FIG. 1 is a cross sectional view through, in this instance, a jet type applicator or coater showing the clearable, adjustable filter or screen of the present invention positioned within of the head of the jet coater, upstream of a nozzle orifice thereof

FIG. 2 is a cross sectional view through the filter portion of the coater taken along line 2-2 of FIG. 1 showing the filter slots in nearly a closed position.

FIG. 2A is a partial cross sectional view of a portion of the filter but showing the slots in a full open position taken on 2A-2A at FIG. 3.

FIG. 2B is a partial view similar to FIG. 2A but showing slots 26C and D formed at an angle in the plate 32C and wall 28C.

FIG. 3 is a cross sectional view through the filter taken along line 3-3 of FIG. 1.

FIG. 3A is a partial cross sectional view similar to FIG. 3 of a portion of the filter but showing the slots in a full open position.

FIG. 4 is a cross sectional view through the head of the jet coater showing an alternative position for the adjustable filter or screen in a metering chamber of the head of the jet coater, upstream of the nozzle orifice thereof.

FIG. 5 is a schematic elevational view of another web coating apparatus showing the present invention in jet coater for coating but one side of a web, and the related structures of the coating apparatus.

FIG. 6 is a schematic elevational view of yet another web coating apparatus, known as a film press, for coating both sides of a downrunning web.

FIG. 7 is a schematic elevational view of a further web coating apparatus with a down running web coating but one side thereof.

FIG. 8 is a schematic elevational view of another film press for coating both sides of a up running web.

### DETAILED DESCRIPTION OF PREFERRED EMBODIMENTS

Referring now to the drawings in greater detail, there is illustrated therein a coater 12 having a screen or filter therein, in this instance, an adjustable or clearable filter 10 of the present invention internal of the jet type coater 12.

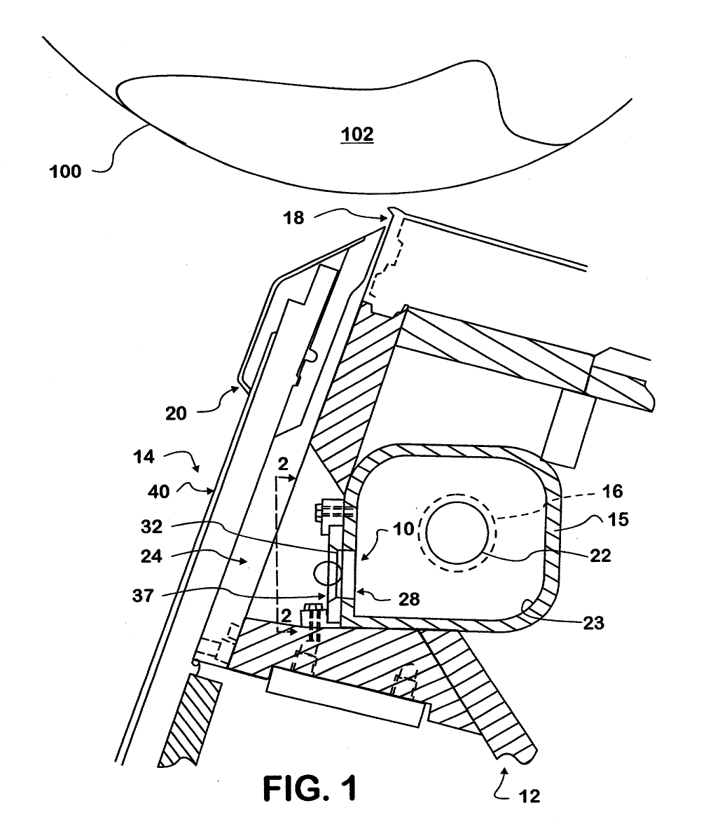

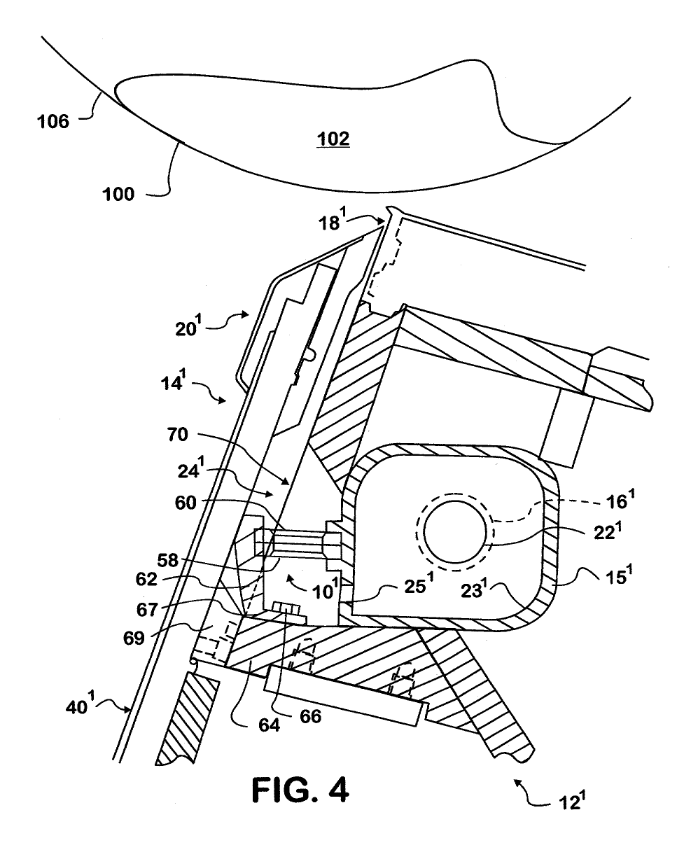

As shown in FIGS. 1 and 4, the filter 10 is positioned internally within a head 14 of the jet coater 12, at a suitable position between an entrance 16 (shown in dotted lines) on one end into the support beam 15 for the head 14 through which coating is received under high pressure and a coating application exit 18 which is typically referred to as a jet nozzle orifice 18 within a nozzle portion 20 of the head 14. A flush out exit 22 (shown in solid line) is on the opposite end of entrance 16 for flushing the reservoir or distribution header 23 formed within the beam 15.

The adjustable or clearable filter 10 can, for example, as shown, be incorporated into a flushable distribution header 23 of the head 14, or can be alternatively elsewhere positioned, such as within a metering channel 24 of the head 14, downstream of the distribution header 23 for clearability, on the run, and cleanability, as necessary.

The first embodiment of filter 10, illustrated in FIGS. 1 through 3A in detail, is incorporated with and forms a part of the distribution header 23. Here, a plurality of slots 26A and B are machined through a wall area 28 of the distribution header 23 adjacent the metering channel 24. Over this slotted wall area 28 is movably positioned a slotted plate 32 which coacts with the slotted wall area 28, creating the adjustable filtering or screen openings of the filter 10.

In a preferred embodiment, it is believed that machining of the slots 26A and B of the filter 10 is best accomplished when the plate 32 is engaged over the distribution header wall area 28, with the slots 26A and B being machined through both structures, i.e., the plate 32 and the wall area 28, simultaneously, to assure accuracy and precision of alignment of the slots 26A and B thereof.

The moveable plate 32 may be held or engaged to the distribution header wall area 28 using any suitable engagement means 34, such as, for example, through use of clamping strips or retaining bars 36, secured to the wall area 28 by cap screws 38 or the like. The retaining bars 36 can be full length or be segmented and spaced uniformly across the width of the distribution header. Of course as mentioned above, other retaining means could also be used.

A primary reason for placing the filter 10 at an entrance 36 into the metering channel 24, is to position the filter 10 as close as possible to the nozzle orifice 18. In this position, it is believed that more agglomerates in the coating may be screened out or filtered than is possible with filters in a more remote upstream position. A second reason is to provide a filter 10 which can be cleared, on the run, and cleaned, as necessary, to remove any coating agglomerates trapped therein by as simple a manner as possible.

In this respect, the distribution header 23, in the form of a reservoir or chamber is flushable, with high pressure flushing or washing cleaning the filter 10 from the inside out, such washing being accomplished on the run. It is to be understood that supply of extra coating from opening 16 to opening 22 will flush the filter. Alternatively, the filter 10 can also be cleaned from the outside in, by removing or opening an exterior nozzle wall 40, allowing access to the filter 10 to hose it off with say water. For example, this wall may be pivotally mounted on the beam 15 to be operable.

It will be understood by those skilled in the art that such clearing on the run with coating liquid may produce sections of defectively coated paper which may be marked and slabbed off during further processing or pulping if necessary.

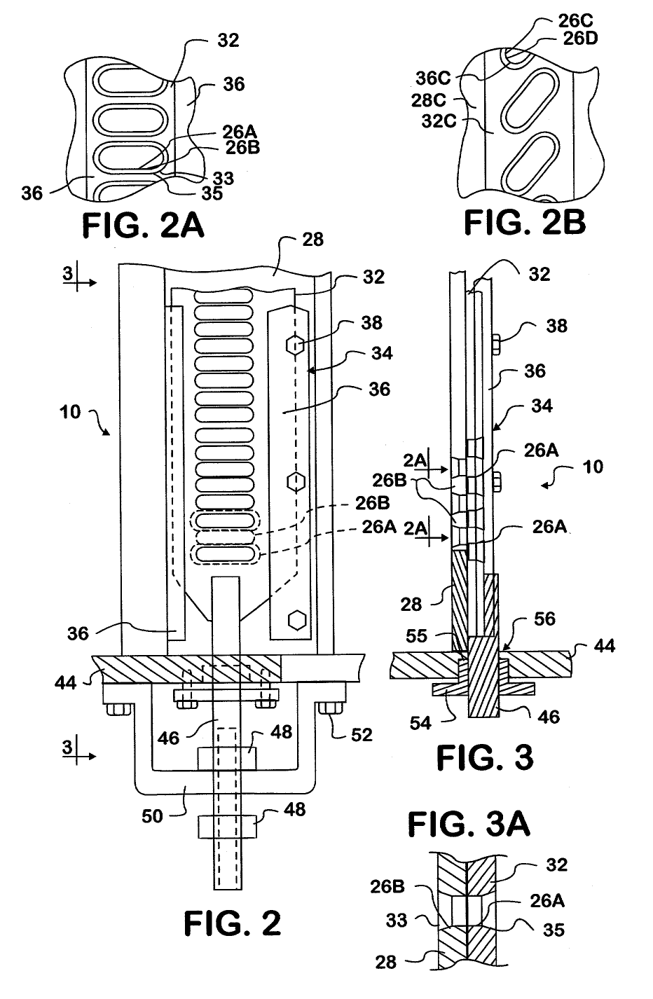

Turning now to the more detailed views of the filter 10 provided in FIGS. 2 and 3, it will be understood that the moveable plate 32 slides along an elongate axis thereof extending across the web 100 (FIG. 1) in a cross machine direction such that the material of the plate 32 between the slots 26A therein can be made to overlie a desired area of the cooperating slots 26B in the wall area 28 of the distribution header 23, allowing for adjustability of the size of the opening formed by the cooperating slots 26A and B, the wall area 28 and the plate 32. In FIGS. 2 and 3, these slots 26A and B are aligned to be nearly closed, and in FIGS. 2A and 3A these slots 26A and B are fully opened.

Thus, the degree of relative movement between the plate 32 and the slotted wall area 28 determines the size of opening formed and of the particles which are allowed or not allowed to pass therethrough. It should be understood that any size opening between fully opened and fully closed could be achieved. As shown in FIG. 2B, to minimize any peaking at slots, and valleys between slots, the slots 26C and 32C and slot 26D formed in wall area 28C could be formed at an angle say of anywhere from 45° to 10°.

It is preferred to select the size of the slots 26A and B to a size slightly smaller than the maximum width dimension of the nozzle orifice 18 likely to be run, the size of which may also be made adjustable in some coater heads. While running then if needed, the actual overlap of slots 26A and B can be selected to be slightly smaller than the dimension of the nozzle actually being run. This assumes that the nozzle width can actually be adjusted. Should the nozzle orifice width be fixed then possible the slot size for 26A and B could be selected to be of a smaller width.

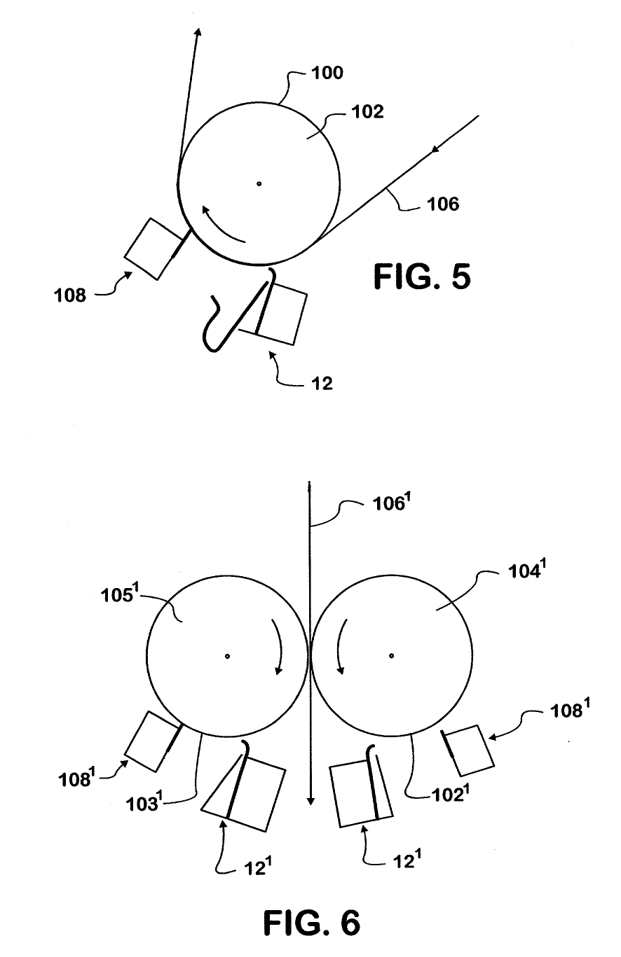

With a smaller size to the filter slot 26A and B, any coating agglomerates would effectively be collected by the filter 10, rather than being allowed to reach and then plugging the nozzle orifice 18, as it is known that a plugged or partially plugged nozzle orifice 18 causes skip coat on a paper web 106 (see FIG. 5).

In a preferred embodiment, the clearance between the moveable plate 32 and the retaining bar(s) 36 is preferably 0.010-0.015 inch, as the nozzle orifice 18 is typically open more than 0.030 inch.

With respect to the filter slots 26A and B, these slots may be in a size range of approximately 0.500×1.500 inches, with the entrance and exits to the slots 26A and B being chamfered, as best illustrated by the numerals 33 and 35 in FIG. 3, to enhance the flow of coating medium therethrough and to minimize pressure losses.

In a preferred embodiment, the slots 26A and B are spaced apart approximately 1.000 inch, center to center, with a length of the filter slots 26A and B being approximately 1.25 to 2.0 times the length of the nozzle 20, though this should not be construed as limiting. The percentage of filter slot width to orifice slot width is in the range of 83% to 98%. For example, an orifice slot width range of 0.030 inches to 0.058 inches results in a filter, slot range of 0.025 inches to 0.051 inches respectively.

In FIGS. 2 and 3, an end wall 44 of the head 14 is shown and a rod 46 is shown extending through this end wall 44, the rod 46 being formed integral with or connected to the moveable plate 32. This rod 46 can be engaged to any suitable moving means (not shown), such an hydraulic cylinder, motorized screwjack, or other suitable device in a manner to cause the moveable plate 32 to move along its elongate axis until a desired filter slot 26 size is achieved. Stop means 48, such as lock or jamb nuts 48, are used to control the available degree of plate movement by coaction with a bracket 50, defined below. It is preferred to set the overlap of slots 26A and B to a size 0.001-0.005 inch width smaller than the size of the width of the nozzle orifice 18 while filtering is being accomplished, with the slots 26 being set to a fully open position (FIGS. 2A and 3A) for cleaning and flushing or clearing.

A bracket 50 is proposed for use in limiting the motion of the moveable plate 32, the bracket 50 being engaged to the end wall 44 by exemplary cap screws 52 in the illustrations. It should be understood, however, that any other suitable means such as positioning bolts or screws or the like could be utilized to limit plate 32 movement, so the exemplary embodiment shown should not be construed as limiting.

It will also be understood that a seal 54, such as a compression packing ring 55, may be used to seal a space 56 between the rod 46 and the end wall 44 through which the rod 46 passes against possible coating leakage therethrough.

Also, in FIG. 2, the slots 26A and B are best shown in the barely open position thereof, whereas in FIGS. 2A and 3A, a fully open position of the slots 26A and B is illustrated. It should be understood that the filtering position could be anywhere in between but closer to that shown in FIG. 3A and in FIG. 2. If desired, an automated control system can be provided to control the movement of the rod 46 and/or the slot 26 size.

Turning now to FIG. 4, the further embodiment positioning the filter 10′ in the metering channel 24, is illustrated. As noted, parts similar to those shown in FIGS. 1-3, and FIG. 4 are primed, that is 10 is shown as 10′. When the filter 10′ is positioned thusly, the entire filter can be cleaned by hosing off the filter 10′ after opening the exterior nozzle wall 40′. Again, the header beam 15′ forms on its interior a reservoir 23′ which has a plurality of openings 25′ extending across the width of the coater 12′ which permit flow of coating out of the header.

In this second embodiment, a first plate 58 serves as a stationary member while a second, movable plate 60 serves as a moveable member, with action and functionality similar to that of the filter 10 of FIGS. 1 to 3A.

In this second embodiment, support bars 62 extending upwardly from a bottom wall 64 of the metering channel 24′, support the filter 10′ within the metering channel 24′ with cap screws 66 illustrated as the securement means 66 of choice, although bolts or other screws or other structure could be used as well. These support bars 62 can be continuous in form along the width of the head 14′, but may be intermittently relieved across the width of the head 14′ to provide a reduction in friction between the filter plates 58 and 60, easing the setting thereof to form a slot 26A′ and B′ of desired size. The support bars 62 have spaced openings 67 to allow for draining the metering channel when the nozzle wall 40′ is opened for cleaning and a seal 69 to close the area when operating.

It is seen here also, that the metering channel 24′ decreases in width toward the nozzle orifice 18′, with the filter 10′ being positioned upstream thereof, in a wider area 70 of the metering channel 24′.

Also, as a method of clearing any obstruction at the nozzle orifice 18 or 18′, either filter 10 or 10′ may be closed off completely for a very short interval and then fully opened, to provide a pressure pulse to the nozzle orifice 18 or 18′ to dislodge any agglomerate matter producing an obstruction thereof.

By way of environment for the coater 12 and the filter 10 and method disclosed herein, FIGS. 5 to 8 are presented. In FIG. 5, a web 106 is supported and transported by a roll surface 100 of a roll 102. This Figure shows that the jet coater 12 is used to apply or jet the just filtered coating onto the web 106, which film of coating is then doctored by doctor means 108 from the paper web 106 to the desired coat weight. It should be understood that the doctor means may be either a blade or a roll.

FIG. 6 is also presented. It shows two jet coaters 12′ that are used to spray a jet or curtain of the just filtered coating onto surfaces of rolls 102′ and 103′ to form a film, which film is doctored to the desired thickness by doctors 108′. This film of desired thickness on each of rolls 102′ and 103′ is transferred to web 106′ as it passes through the nip between rolls 104′ and 105′. The web continues on for further processing, such as drying and eventually forms a paper roll. Again, the doctoring could be by blade, smooth or grooved rod.

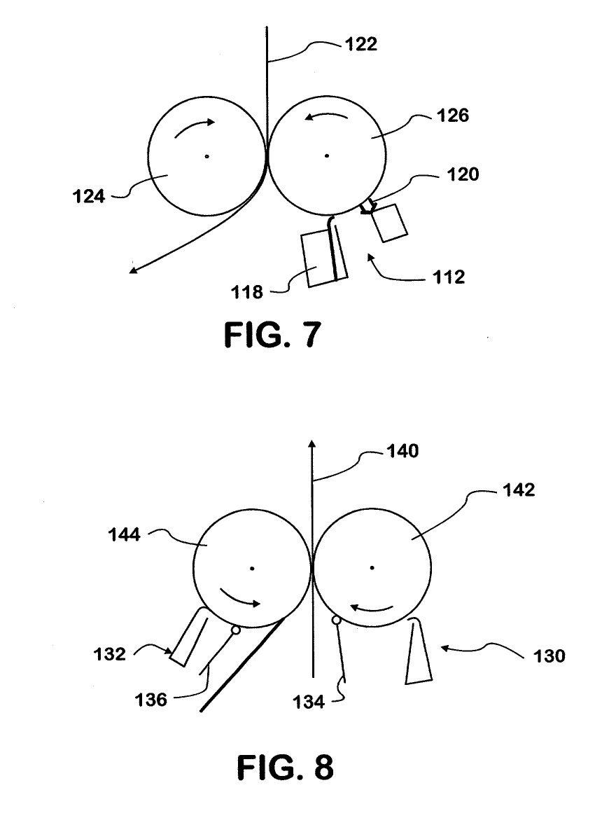

Again, FIG. 7 shows the present invention incorporated into the coater 112 having a jet applicator 118 and a doctoring unit (shown here with a doctor roll 120). It being understood that a blade could also be substituted, which coats one side of the web 122 running in a downward direction between two rolls 124 and 126. The coater 112 incorporates a filter structure and method of the present invention.

FIG. 8 shows two coaters 130 and 132 having filters of the present invention with doctors 134 and 136 (in these instances rolls) used to coat both sides of an up running web 140 running between the nip of two rolls 142 and 144.

As noted herein, roll rotation and web travel direction are indicated by arrows or arrowheads shown in the respective rolls and webs.

As described above, the coater and adjustable and/or internal filter therein and method disclosed herein provide a number of advantages, some of which are inherent in the invention and others of which are set forth above. Also, modifications may be proposed without departing from the teachings herein. Accordingly, the scope of the invention is only to be limited as necessitated by the accompanying claims. It should be understood that these claims cover the structure and steps disclosed therein and equivalent structure and steps.

What is claimed is:

1. A process for operating a jet coater which applies a jet of coating liquid to a moving surface to coat a web of paper, said filter having two relatively movable structures comprising the steps of admitting the coating into a coating head of the jet coater under pressure, passing the coating through a filter, filtering the coating with the filter, at least periodically moving one structure of the filter relative to the other structure to clear coating agglomerates out of the filter, and forcing the coating out in a jet through a nozzle orifice onto a moving surface for coating paper.

2. A process as in claim 1, including the subsequent step of metering the filtered coating onto the moving surface.

3. A process as in claim 2, wherein said step of metering subsequently comprises doctoring the filtered coating on the moving surface.

4. The process of claim 3, wherein the step of doctoring comprises blading the coating.

5. The process of claim 3, wherein the step of doctoring comprises doctoring the coating with a doctor roll.

6. The process of claim 1, comprising the step of applying the filtered coating to a moving surface which is formed by the paper web.

7. The process of claim 1, comprising the step of applying the filtered coating to a moving surface which is formed by a roll surface and transferring the filtered coating from the roll surface to the moving paper web.

8. The process of claim 1, comprising the step of at least periodically cleaning the filter.

9. The process of claim 1, comprising the further step of at least periodically purging the filter to maintain its effectiveness.

10. The process of claim 1, wherein said filtering step prevents particles at least as large as the nozzle orifice from being forced out in a jet onto the moving surface and from obstructing the nozzle orifice.

11. The process of claim 1, wherein the forcing out in a jet is accomplished through a nozzle orifice of a predetermined size and said filtering prevents coating particles of a size at least equal to the nozzle orifice size from reaching the nozzle orifice.

12. The process of claim 1, comprising forming said filter into a plurality of slots smaller than the size of said nozzle orifice so that coating agglomerates capable of plugging the nozzle orifice are prevented from reaching said nozzle orifice by filtering.

13. The process of claim 1, further comprising the step of distributing the coating across the width of the coater after the step of admitting the coating, said filtering occurring after said step of distributing the coating across the width of the coater.

14. The process of claim 13, further comprising the step of metering the coating in a narrowing gap just prior to forcing the coating out of the nozzle orifice in a jet, said filtering occurring in close proximity to the nozzle orifice.

15. A jet coater which applies a jet of coating liquid onto a moving surface to coat paper, comprising a coater head, said coater head having an entrance for the admission of coating liquid under pressure and a nozzle orifice therein for application of coating onto the moving surface, a filter within said coater head located between said entrance and said nozzle orifice for filtering the coating liquid after passing through said entrance and before reaching the nozzle orifice, said filter comprises two relatively movable structures and movement of one of said structures relative to the other clears said filter, whereby coating agglomerates which may be contained in the coating liquid are filtered out by said filter before reaching the nozzle orifice and preventing nozzle orifice blockage.

16. The coater as in claim 15, further comprising metering means for leveling the coating on said moving surface, said metering means being located downstream of said nozzle orifice, whereby coating agglomerates are filtered out by said filter before reaching said metering means and accumulating thereon.

17. The coater as in claim 15, wherein said metering means comprise a doctor on the moving surface.

18. The coater as in claim 17, wherein said doctor comprises a doctor blade.

19. The coater as in claim 18, wherein said doctor comprises a metering roll.

20. The coater as in claim 15, wherein said moving surface comprises a moving paper web.

21. The coater as in claim 15, wherein said moving surface comprises the outer surface of a roll, said roll subsequently transferring coating applied to it to a moving paper web.

22. The coater as in claim 15, further comprising means for at least periodically cleaning said filter.

23. The coater as in claim 22, wherein said means for at least periodically cleaning said filter are located in said coater head.

24. The coater as in claim 15, further comprising means for at least periodically purging said filter.

25. The coater as in claim 24, wherein said means for at least periodically purging said filter are located on said coater head.

26. The coater as in claim 15, wherein said filter extends generally across the width of the moving surface.

27. The coater as in claim 26, wherein said filter extends generally perpendicularly to the direction of movement of said moving surface.

28. The coater as in claim 15, wherein said filter comprises a plurality of slots being located in said structure to provide a filtering action.

29. The coater as in claim 28, wherein said plurality of slots extend across the width of the moving structure.

30. The coater as in claim 29, wherein said structure forms a part of said coater.

31. The coater as in claim 15, wherein said structures are relatively slidable.

32. The coater as in claim 15, wherein said structures are relatively rotatable.

33. The coater as in claim 15, wherein said structures are relatively pivotable.

34. The coater as in claim 15, wherein the adjustable nozzle orifice is of a predetermined size, and said filter can prevent coating agglomerates greater than at least said predetermined size from reaching the nozzle orifice.

35. The coater as in claim 15, wherein said filter has a plurality of slots smaller than the size of said nozzle orifice so that agglomerates capable of plugging said nozzle orifice are prevented by said filter from reaching said nozzle orifice.

36. The coater of claim 15, further comprising a distribution header, said header being located within said coater head, after said entrance but before said nozzle orifice.

37. The coater of claim 36, wherein said filter is located at said distribution header.

38. The coater of claim 37, wherein said filter is located downstream of said distribution header.

39. The coater of claim 38, further comprising a metering channel downstream of said distribution header but before said nozzle orifice, said filter being located at said metering channel.

40. The coater of claim 37, further comprising a distribution header and metering channel, said metering channel being downstream of said distribution header and widening in width and then narrowing in width as it approaches the nozzle orifice, said filter being located in the metering channel before the narrowing in width of the metering channel.
